(19) United States
(12) Patent Application Publication
(10) Pub. No.: US 2015/0129460 A1
(43) Pub. Date: May 14, 2015

(54) THERMAL CRACKING ADDITIVE COMPOSITIONS FOR REDUCTION OF COKE YIELD IN DELAYED COKING PROCESS

(71) Applicant: Indian Oil Corporation Limited, Mumbai (IN)

(72) Inventors: Terapalli Hari Venkata Devi PRASAD, Faridabad (IN); Ponoly Ramachandran PRADEEP, Faridabad (IN); Satyen Kumar DAS, Faridabad (IN); Jagdev Kumar DIXIT, Faridabad (IN); RAJESH, Faridabad (IN); OM PARKASH, Faridabad (IN); Samik Kumar HAIT, Faridabad (IN); Eswar Prasad DALAI, Faridabad (IN); Ram Mohan THAKUR, Faridabad (IN); Gautam THAPA, Faridabad (IN); Debasis BHATTACHARYYA, Faridabad (IN); Brijesh KUMAR, Faridabad (IN); Biswapriya DAS, Faridabad (IN); Santanam RAJAGOPAL, Faridabad (IN); Ravinder Kumar MALHOTRA, Faridabad (IN)

(21) Appl. No.: 14/541,031

(22) Filed: Nov. 13, 2014

(30) Foreign Application Priority Data
Nov. 14, 2013 (IN) 3228/MUM/2013
Mar. 31, 2014 (IN) 1225/MUM/2014

(51) Int. Cl. B01J 27/182; C10G 51/04; C10B 57/06

(52) U.S. Cl. CPC B01J 27/182; C10B 57/06; C10G 51/04
USPC 208/50; 502/214

(57) ABSTRACT

The present invention is directed to novel thermal cracking additive compositions for reduction of coke yield in Delayed Coking process and method for preparing the same. The present invention also provides that the thermal cracking additive compositions of the present invention are in micron-size and nano-size. Further, the present invention provides a process of thermal cracking of heavy petroleum residue used in petroleum refineries using Delayed Coking process to produce petroleum coke and lighter hydrocarbon products with decreased coke yield and increased yield of liquid and/or gaseous products.

### FIELD OF INVENTION

The present invention relates to a thermal cracking additive composition for reduction of coke yield in Delayed Coking process and method for preparing the same. The present invention also provides that the thermal cracking additive composition is in micron-size and nano-size. Further, the present invention also relates to a process of thermal cracking of heavy petroleum residue used in petroleum refineries using Delayed Coking process to produce petroleum coke and lighter hydrocarbon products with decreased coke yield and increased yield of liquid and/or gaseous products.

### BACKGROUND OF THE INVENTION

In the Delayed Coking process used in the petroleum refineries there are three varieties of cokes that are generated namely, Fuel grade coke, Anode grade coke and Needle coke. Fuel grade coke is used as fuel in furnaces etc., as the name suggests and it has the lowest cost per unit weight. Other two grades of coke fetch higher value than fuel grade coke, wherein Needle coke being the highest value product among the two and refiners may look into production of needle coke as an opportunity for revenue generation. The excess volume of low value petroleum coke generated in Delayed Coking unit poses the refiners with the perennial problem of coke handling, storage, removal and marketing. Also, the feed through put to the Delayed Coking unit is limited by the bed height of the coke generated inside the coking drum, by having to divert the feed from one coke drum to another empty drum. Therefore, it is desirable to have a process/material means to reduce the height of coke bed generated inside the coke drum, which will enable higher amounts of feed to be processed inside the coke drum.

Manipulating the process parameters like employing low recycle ratio, low coke drum pressure during operation etc. can reduce the coke yield as known by those who are well versed with art of Delayed Coking Various additives have been tried in the past for reducing the yield of coke in Delayed Coking process.

U.S. Pat. No. 4,378,288 have disclosed the use of free radical inhibitors like benzaldehyde, nitrobenzene, aldol, sodium nitrate etc. with a dosage of 0.005-10.0 wt % of the feedstock which majorly have been Vacuum tower bottom, Reduced crude, Thermal tar or a blend thereof. Additives used included only liquid phase additives.

Chevron Research Company in their U.S. Pat. No. 4,394,250 have disclosed use of additives such as cracking catalysts like Silica, alumina, bauxite, silica-alumina, zeolites, acid treated natural clays, Hydrocracking catalysts such as metal oxides or sulfides of groups VI, VII or VIII and Spent catalyst from FCC in presence of Hydrogen at a dosage of 0.1-3 wt % of the feedstock Hydrogen flow 50-500 SCF per Kg/cm² (g) where the additive is contacted with the feedstock before its entry into the coke drum. Hydrocarbon feedstock used in Delayed Coking have been shale oil, coal tar, reduced crude, residuum from thermal or catalytic cracking processes, hydrotreated feedstocks, etc.

Similarly, US patent publication No. 2009/0209799 discloses FCC catalysts, zeolites, alumina, silica, activated carbon, crushed coke, calcium compounds, Iron compounds, FCC Ecat, FCC spent cat, seeding agents, hydrocracker catalysts with a dosage of <15 wt % of the feed which is majorly a suitable Hydrocarbon feedstock used in Delayed Coking of boiling point higher than 565° C. to obtain a reduction in coke yield of about 5 wt %. A number of liquid and solid phase additives have been described for achieving objectives like reduction of coke yield on hydrocarbons feedstocks, suitable for processing in Delayed Coker unit, subjected to Standard Delayed Coker operating conditions in the known art. Range of the temperature studied is about 400-650° C. Reaction pressure considered 1 atm to 14 atm. Various methods for contacting hydrocarbon feedstock and additives like mixing with feed, injecting from coke drum top etc. have also been described. In some recent patents (US 2009/0209799), injection of additives into coker drum has been claimed as superior as compared to mixing with feed.

Most of the patents have disclosed the use catalysts in liquid and solid phase, broadly falling in the categories of free radical inhibitors, free radical removers, free radical accelerators, stabilizers and cracking catalysts. Reported additive injection was in the range of 0.005 to 15 wt % of the feed.

U.S. Pat. No. 8,361,310 B2 depicts injection of an additive package comprising catalysts, seeding agents, excess reactants, quenching agents and carrier fluids into the top of the coke drum, for various utilities like coke yield reduction.

U.S. Ser. No. 12/498,497 discloses anionic clay mixed with the hydrocarbon feedstock for reducing the coke yield.

### SUMMARY OF THE INVENTION

It is an objective of the present invention to provide means for reduction of coke yield in a Delayed Coking process.

In a primary aspect of the present invention, there is provided a thermal cracking additive composition for reduction of coke yield. The additive composition comprises: (i) 40-85 wt % alumina, (ii) 5-20 wt % colloidal silica having silica content ranging from 20-45 wt %, and (iii) 0.1-13 wt % phosphate compound, wherein said alumina comprises boehmite alumina and 2-40 wt % dispersible alumina. In preferred embodiment, the dispersible alumina has crystallite size ranging from 4.5 to 40 nano meters.

In another embodiment, the present invention provides a micron-sized thermal cracking additive composition for reduction of coke yield, wherein the composition comprises: (i) 40-85 wt % alumina, (ii) 5-20 wt % colloidal silica having silica content ranging from 20-45 wt %, and (iii) 0.1-13 wt % phosphate compound, wherein said alumina comprises boehmite alumina and 2-40 wt % dispersible alumina. In preferred embodiment, the dispersible alumina has crystallite size ranging from 4.5 to 40 nano meters. In another preferred embodiment, the additive is micron sized with average d₅₀ particle size in the range of 5-150 microns.

In a further embodiment, the present invention provides a nano-sized thermal cracking additive composition for reduction of coke yield, wherein the composition comprises: (i) 40-85 wt % alumina, (ii) 5-20 wt % colloidal silica having silica content ranging from 20-45 wt %, and (iii) 0.1-13 wt % phosphate compound; wherein said alumina comprises boehmite alumina and 2-40 wt % dispersible alumina. In preferred embodiment, the dispersible alumina has crystallite size ranging from 4.5 to 40 nano meters. In another preferred embodiment, the nano-sized additive has a volume average d₅₀ diameter of 20 to 1000 nanometers.

In another embodiment, the phosphate compound in the additive is selected from a group comprising phosphoric acid, monobasic phosphate compounds, dibasic phosphate compounds, tri basic phosphate compounds, diammonium hydrogen ortho phosphate and combinations thereof.

In a further embodiment, the dispersible alumina in the additive composition is selected from the group comprising pseudo boehmite, gamma-alumina, alpha alumina, Pural 200, Pural 400, Disperal 40 and combination thereof. In a preferred embodiment, the dispersible alumina has crystallite size ranging from 4.5-40 nm.

In another aspect, the present invention provides a process for the preparation of thermal cracking additive composition for reduction of coke yield. The process for preparing a thermal cracking additive composition of the present invention comprises the steps of: (a) treating boehmite alumina with demineralized water to obtain boehmite slurry; (b) treating boehmite slurry with phosphate compound to obtain phosphate treated boehmite slurry; (c) gelling dispersible alumina employing mineral or organic acid; (d) adding colloidal silica to product of step (c) at pH 1 to 5; (e) adding the phosphate treated boehmite slurry to the product of step (d); (f) spray drying the product obtained in step (e); and (g) calcining the spray dried particles of step (f) to obtain the additive composition. In one embodiment, the additive composition so obtained is micron-sized additive composition. In another embodiment, the process for preparing the thermal cracking additive composition of the present invention further comprises the step of milling the calcined additive composition to obtain nano-sized additive composition.

In one embodiment, in the process for preparing a thermal cracking additive composition of the present invention, the mineral or organic acid is selected from nitric acid, formic acid, and acetic acid.

In yet another aspect, the present invention provides a process for reducing coke yield in Delayed Coking process. The process for reducing coke yield in Delayed Coking process comprises the steps of: (a) contacting a feedstock with the thermal cracking additive composition of the present invention in a coke drum; and (b) separating the cracked product to obtain different fractions.

In one embodiment, in the process for reducing coke yield in Delayed Coking process of the present invention, the contacting of feedstock with the additive is carried out by feeding a predetermined quantity of the additive to the coke drum before feeding the hydrocarbon feedstock into the coke drum. In another embodiment, the step of contacting the feedstock with the additive is carried out by mixing the additive at a predetermined flow rate into the hydrocarbon feedstock before entering the feed heater furnace, in the transfer line. In yet another embodiment, the step of contacting the feedstock with the additive is carried out by injecting the solid phase additive into the coke drum during the feeding of hydrocarbon into the drum, through injection nozzle(s) located at suitable part of the drum, preferably at the top section. The above said steps for contacting the feedstock with the additive composition can also be carried out in multiple combinations.

In a preferred embodiment, the step of contacting a feedstock with the thermal cracking additive composition of the present invention is performed at a temperature range of 450-600° C. In another preferred embodiment, the step of contacting a feedstock with the thermal cracking additive composition of the present invention is performed at a pressure range of 0.5-5 kg/cm².

In yet another preferred embodiment, in the process for reducing coke yield in Delayed Coking process of the present invention, the micron-sized thermal cracking additive composition is used in the concentration range of 0.01-5 wt % of the feedstock. In another preferred embodiment, in the process for reducing coke yield in Delayed Coking process of the present invention, the nano-sized thermal cracking additive composition is used in the concentration range of 50 ppm to 40,000 ppm of the feedstock.

In yet another embodiment, the micron sized thermal cracking additive is used in solid form or in a dispersion form in the process for reducing coke yield in Delayed Coking process of the present invention.

In another embodiment, the nano-sized thermal cracking additive is used in dispersion form in the process for reducing coke yield in Delayed Coking process of the present invention.

In a preferred embodiment, the micron-sized thermal cracking additive composition or the nano-sized thermal cracking additive composition in dispersion form is used in combination with a liquid dispersion medium selected from the group consisting of feedstock, gas oil, lighter hydrocarbons, residue, solvents, water or mixtures thereof.

In a preferred aspect, the bottom product (boiling above 350° C.+) yield is reduced by 1-3 wt % in the process for reducing coke yield in Delayed Coking process of the present invention.

In another preferred aspect, the LPG yield is increased by 1-2 wt % in the process for reducing coke yield in Delayed Coking process of the present invention.

In another preferred aspect, the naphtha (C5-150° C.) yield is increased by 1-2 wt % in the process for reducing coke yield in Delayed Coking process of the present invention.

In yet another preferred aspect, in the process for reducing coke yield in Delayed Coking process of the present invention, the reduction in coke yield is 1 wt % to 5 wt % with respect to base case.

### BRIEF DESCRIPTION OF THE DRAWINGS

FIG. 1 shows schematic diagram of a conventional Delayed Coking process.

FIG. 2 shows reduction of coke yield using micron sized solid thermal cracking additive and nano sized solid thermal cracking additive of the present invention.

FIG. 3 shows reduction of coke yield using different concentrations of nano-sized solid thermal cracking additive of the present invention.

### DETAILED DESCRIPTION OF THE INVENTION

While the invention is susceptible to various modifications and alternative forms, specific embodiment thereof will be described in detail below. It should be understood, however that it is not intended to limit the invention to the particular forms disclosed, but on the contrary, the invention is to cover all modifications, equivalents, and alternatives falling within the scope of the invention as defined by the appended claims.

One of the major concerns in a Delayed Coking process is to address the problem of production of coke and the associated disadvantages. There have been many efforts to reduce the production of coke in a Delayed Coking process. The present invention is providing a novel thermal cracking additive composition for use in a Delayed Coking process, whereby the use of such novel thermal cracking additive composition reduces the yield of coke. The present invention also provides the novel thermal cracking additive compositions of the present invention in micron-sized and nano-sized compositions. The novel thermal cracking additive compositions of the present invention do not settle in the bottom when mixed with liquid hydrocarbons and thereby provide processing advantages due to their smaller particle size. It is also contemplated that the present invention may prove useful in addressing other problems also in a number of technical areas.

Accordingly, the present invention provides a thermal cracking additive composition for reduction of coke yield in a Delayed Coking process. The additive composition comprises:
(i) 40-85 wt % alumina,
(ii) 5-20 wt % colloidal silica having silica content ranging from 20-45 wt %, and
(iii) 0.1-13 wt % phosphate compound, wherein said alumina comprises boehmite alumina and 2-40 wt % dispersible alumina. The dispersible alumina has crystallite size ranging from 4.5 to 40 nano meters.

The said thermal cracking additive composition of the present invention is preferably in micron-size with average d₅₀ particle size in the range of 5-150 microns. More preferably, the said thermal cracking additive composition of the present invention is in nano-size with volume average d₅₀ diameter of 20 to 1000 nanometers.

As used herein, the term “alumina” refers to alumina comprising boehmite alumina and 2-40 wt % dispersible alumina. The dispersible alumina has crystallite size ranging from 4.5 to 40 nano meters.

The “boehmite alumina” or “boehmite” is an aluminum oxide hydroxide (γ-AlO(OH) mineral which is used as a binder in catalyst preparation with Al₂O₃ content of around 64-80 wt %.

The term “dispersible alumina” or “large pore dispersible alumina” refers to dispersible alumina having large pore size ranging from 30-400 Å. Dispersible alumina is selected from the group comprising pseudo boehmite, gamma-alumina, alpha alumina, Pural 200, Pural 400, Disperal 40 and combination thereof. The dispersible alumina has crystallite size ranging from 4.5-40 nm.

As used herein, the term “colloidal silica” refers to suspensions of fine amorphous, nonporous, and typically spherical silica particles in a liquid dispersed phase. Colloidal silica is most often prepared by partial neutralization of alkali-silicate solution to form silica nuclei of particle size ranging from 100-400 nanometers.

As used herein, the term “phosphate” or PO₄ refers to a phosphate compound selected from the group comprising phosphoric acid, monobasic phosphate compounds, dibasic phosphate compounds, tri basic phosphate compounds, diammonium hydrogen ortho phosphate and combination thereof.

Without being bound by theory, the inventors believe that, with increasing alumina concentration along with silica, catalytic function of the catalyst increases. At 100% alumina concentration, catalytic function drastically decreases. PO₄ is used for binding material along with silica. Mainly, it improves the catalyst physical properties here and also contributes in retaining the catalytic function. After certain concentration of PO₄, binding properties decrease. However, to get optimum coke reduction in the present invention, the acidity of the catalyst is optimized.

The present invention also provides a process for preparing the thermal cracking additive composition for reduction of coke yield and a process for reducing coke yield in a Delayed Coking process. The present invention also provides that the thermal cracking additive composition is in micron-size and/or nano-size.

### Micron-Sized Additive Composition

In one embodiment the present invention discloses an improved Delayed Coking process in which the hydrocarbon feedstock is heated to the thermal cracking temperature and is introduced into the coke drum kept at desired pressure, until it cracks into lighter products. The improvement comprises adding an additive of the present invention inside the coke drum to mix with the hot hydrocarbon feedstock in amounts sufficient to cause a reduction in coke yield and increase in liquid yield, in particular the naphtha yield.

The liquid hydrocarbon feedstock to be used in the process can be selected from a group comprising of, but not limited to heavy hydrocarbon feedstocks like vacuum residue, atmospheric residue, deasphalted oil, shale oil, coal tar, clarified oil, residual oils, thermal pyrolytic tar, visbreaker streams, slop oil or blends of such hydrocarbons. The Conradson carbon residue content of the feedstock can be above 6 wt % and density can be minimum of 0.9 g/cc. These hydrocarbon feedstock may be hydrotreated for removal of sulfur and metals before feeding into the process, depending on the requirement. Major aspect of the disclosed invention provides additive composition of the present invention for contacting the hydrocarbon feedstock having feed CCR greater than 6 wt % at thermal cracking conditions which enables enhanced quantity of hydrocarbon feed to be processed and also to decrease the coke yield and increase the liquid and gas product yield.

The micron-sized thermal cracking additive composition comprises: (i) 40-85 wt % alumina, (ii) 5-20 wt % colloidal silica having silica content ranging from 20-45 wt %, and (iii) 0.1-13 wt % phosphate compound, wherein said alumina comprises boehmite alumina and 2-40 wt % dispersible alumina. The dispersible alumina has crystallite size ranging from 4.5 to 40 nano meters. The concentration of the additive composition of the present invention contacting with the feedstock can vary from 0.01 to 5 wt % of the feedstock. The average d₅₀ particle size of the said additive composition can range from 5 microns to 150 microns with the maximum size being decided based on the settling characteristics of the additive particulates in the hydrocarbon liquid.

The additive may be in suitable form, such as a solid powder, slurry, suspension and/or the like. The additives may be added in isolation or along with a carrier fluid. The non limiting examples of the carrier fluid are hydrocarbon liquids of suitable boiling range which may include the feedstock, gas oil, lighter hydrocarbons, residue, solvents, water, steam, nitrogen, inert gases, carbon monoxide, carbon dioxide and/or the like. The solid phase additives may contain acid sites which help to accelerate the cracking reaction rate.

The process of the present invention may use any desired operating temperature ranging from 450 to 600° C., and desired operating pressure inside coke drum ranging from 0.5 to 5 Kg/cm². The use of additives of the present invention alter the physical properties of the coke produced like increasing the bed density of the coke deposited inside the coke drum, thereby effectively reducing the coke bed height enabling a higher through put of hydrocarbon feedstock into the coke drum. The use of the additive composition of the present invention enables the refiner to process higher quantity of hydrocarbon feed and also causes reduction in the coke yield and increase in the liquid product yield, especially of naphtha, at the expense of coker fuel oil.

### Nano-Sized Additive Composition

In another embodiment the present invention discloses a process for thermal cracking of petroleum residue, converting the petroleum residue into liquid and gaseous product streams and solid, carbonaceous petroleum coke as a by-product, using the nano-sized additive composition of the present invention. Particularly the invention discloses an improved process for thermal cracking of petroleum residue by delayed coking using a nano-sized thermal cracking additive composition. The nano-sized thermal cracking additive composition comprises: (i) 40-85 wt % alumina, (ii) 5-20 wt % colloidal silica having silica content ranging from 20-45 wt %, and (iii) 0.1-13 wt % phosphate compound, wherein said alumina comprises boehmite alumina and 2-40 wt % dispersible alumina. The dispersible alumina has crystallite size ranging from 4.5 to 40 nano meters and the volume average d₅₀ diameter of the additive composition is 20 to 1000 nanometers. The said nano-sized additive composition is used in combination with a liquid dispersion medium.

An aspect of the invention discloses the composition of a nano-sized solid phase additive for delayed coking of petroleum residue with increased product yield and decreased coke yield.

Another aspect of the present invention discloses thermal cracking of hydrocarbon feedstocks; with Conradson carbon residue content of the feedstock being preferably above 6 wt % and minimum density of 0.9 g/cc, using a nano-sized solid phase additive.

The petroleum residue used according to the present invention includes, but is not necessarily limited to, vacuum residue, atmospheric residue, deasphalted oil, shale oil, coal tar, clarified oil, residual oils, thermal pyrolytic tar, visbreaker streams, heavy waxy distillates, foots oil, slop oil or blends of such hydrocarbons. The petroleum residue used according to the present invention may be hydrotreated for removal of sulfur and metals before feeding into the process, depending on the requirement.

The nano-sized solid phase additive used according to the present invention is predominantly in amorphous form, having a volume average d₅₀ diameter of 20 to 1000 nanometers, preferably in the range 100 to 500 nanometer and external specific surface area greater than 0.1 m²/g, measured in dispersed condition. Additionally a binder may be used in accordance to the present invention, which may include clay, silica etc.

The nano-sized additives for use in this invention include, but are not necessarily limited to, large pore size active materials of silica, alumina, peptized alumina, aluminium silicates, titanium oxide or mixtures thereof. The phosphate compound used according to the present invention includes, but is not necessarily limited to, phosphoric acid, monobasic phosphate compounds, dibasic phosphate compounds, tri basic phosphate compounds, diammonium hydrogen ortho phosphate and combination thereof. The nano-sized additive can contain phosphate compound up to 13 wt %. The liquid dispersion medium for the additive can be selected from hydrocarbon liquids of suitable boiling range. Some non-limiting examples of dispersion medium include the feedstock, gas oil, lighter hydrocarbons, residue, solvents, water or mixtures thereof.

Nano-sized additive is prepared from micron-sized particles of desired composition using size reduction approach. Examples of size reduction approaches are wet grinding in stirred media mill, planetary ball mill etc. Micro size particles of the additive composition are made in slurry form in water and loaded to the milling chamber of the stirred media mill and milled till the particles are of nanometer size as desired. Dispersants or stabilizing agents can be added to the slurry for keeping nano particles in suspension.

The concentration of the nano sized additive contacting with the feedstock can vary from 50 to 40000 ppm. The nano sized additive may additionally contain acid sites which help to accelerate the cracking reaction rate.

### Method of Reducing Coke Yield in Delayed Coking Process Using the Additive Compositions of the Present Invention

The process for reducing coke yield in Delayed Coking process comprises the steps of: (a) contacting a feedstock with the thermal cracking additive composition of the present invention; and (b) separating the cracked product to obtain different fractions.

The contacting of the additive composition with the feedstock can be achieved in three ways, (a) by feeding a predetermined quantity of the additive to the coke drum before feeding the hydrocarbon feedstock into the coke drum; (b) by mixing the additive at a predetermined flow rate into the hydrocarbon feedstock before entering the feed heater furnace, in the transfer line; or c) injecting the additive into the coke drum during the feeding of hydrocarbon into the drum, through injection nozzle(s) located at suitable part of the drum, preferably at the top section. Also, a combination of these contacting methods can be used. The additive particles are to be selected in such a way so as to minimize the settling of the same in the hydrocarbon liquids being processed. In case of supplying solid additive into the coke drum at the time of feeding of hydrocarbon feedstock, a single or multiple injection nozzles located at any suitable location in the coke drum is used for additive supply. The elevation & orientation of the injection nozzle is selected so as to minimize the entrainment of the solid additive to the coke drum overhead vapor line. In case of supply of additive to the hydrocarbon feedstock, the size and shape of the additive particles are to be controlled to minimize any erosion that may occur in the pipe lines.

Contacting of the nano sized additive in liquid dispersed form, with the feedstock is achieved by mixing the additive at a predetermined flow rate into the hydrocarbon feedstock before entering the feed heater furnace, in the transfer line or in the feed surge drum or storage tank. The size and shape of the additive particles are to be controlled to minimize any erosion that may occur in the pipe lines. The feed is then thermally treated at a temperature, pressure and residence time sufficient to form a lower boiling fraction, a higher boiling fraction and the solid particles of coke. The process of the present invention may use any desired operating temperature ranging from 450 to 600° C., and desired operating pressure inside coke drum ranging from 0.5 to 5 Kg/cm². The use of the micron-sized or nano sized additive causes a reduction in the coke yield and increase in the hydrocarbon product yield. The coke thus formed is separated from the valuable liquid and/or gaseous hydrocarbon product yields.

The following examples are illustrative of the invention but not to be construed to limit the scope of the present invention.

### Examples for Micron-Sized Additive Composition

### Example 1

Experiments were carried out in small scale Micro coker unit using solid additives of different compositions as indicated in Table 1. The Micro coker unit consists of a reactor unit kept in an Electric furnace for heating the feed to the reaction temperature, condenser vessel for collection of liquid products and a gas flow meter. Feed premixed with additive is loaded into the reactor vessel and is pressurized with nitrogen gas to desired pressure of 1 Kg/cm². Heating is carried out using the electric furnace at a controlled rate through Proportional Integral Derivative Controller (PID controller). Reactor is held at the reaction temperature of 486° C. for two hours for completion of thermal cracking reactions. Reactor pressure is kept constant by using a needle valve provided in the gas outlet. Liquid products are condensed and collected in the condenser vessel and gaseous products are measured in a gas flow meter and then vented to atmosphere. The experimental results are shown in Table-2.

TABLE 1
Micron sized solid additives of different Compositions

| Compositions | wt % of Alumina | wt % of Phosphate | wt % of Silica |
|---|---|---|---|
| Additive ‘A’ | 30 wt % | 0.1 wt % | 69.9 wt % |
| Additive ‘B’ | 68 wt % | 10 wt % | 22 wt % |
| Additive ‘C’ | 85 wt % | 15 wt % | — |
| Additive ‘D’ | 68 wt % | — | 32 wt % |
| Additive ‘E’ | 68 wt % | 20 wt % | 12 wt % |

TABLE 2
Results of experiments carried out in Micro coker unit using Micron sized
additive Compositions

| | | | | ΔCoke |
|---|---|---|---|---|
| | | | | yield |
| | Coke | Liquid | Gas | w.r.t. |
| | yield, | yield, | yield, | Base |
| Experiment | wt % | wt % | wt % | case, % |
| Vacuum Residue without additive | 35.21 | 50.04 | 14.75 | 0.00 |
| Vacuum Residue + 1 wt % Additive ‘A’ | 35.15 | 50.0 | 14.9 | −0.17 |
| Vacuum Residue + 1 wt % Additive ‘B’ | 26.5 | 44.0 | 29.5 | −24.74 |
| Vacuum Residue + 1 wt % Additive ‘C’ | 35.18 | 50.06 | 14.76 | −0.085 |
| Vacuum Residue + 1 wt % Additive ‘D’ | 28.2 | 51.8 | 20.0 | −19.91 |
| Vacuum Residue + 1 wt % Additive ‘E’ | 30.2 | 46.6 | 23.2 | −14.23 |
| Vacuum Residue + 0.005 wt % | 35.21 | 50.0 | 14.8 | 0.00 |
| Additive ‘B’ | | | | |

### Example 2

Two experiments were performed in a Delayed Coker pilot plant using vacuum residue feedstock (VR), one without using any additive and a second experiment using the solid phase Additive ‘B’. The Additive ‘B’ is selected for pilot plant experiments based on the data indicated in table 2 (based on reduced coke yield). Delayed coking pilot plant has a coke drum in which the hot hydrocarbon feed preheated inside a furnace, is supplied from the bottom. Facility is provided to inject water to the feed preheat furnace at controlled rate.

Properties of feedstock used in this example are given in Table-3.

TABLE 3
Properties of feedstock

| Feed Properties | Unit | Value |
|---|---|---|
| CCR | Wt % | 22.05 |
| Asphaltene | Wt % | 7.1 |
| Sulfur | Wt % | 5.18 |
| Na | ppm | 4 |
| Mg | ppm | 1 |
| Ni | ppm | 91 |
| V | ppm | 146 |
| Fe | ppm | 10 |
| Paraffins | Wt % | 43.5 |
| Aromatics | Wt % | 56.5 |
| ASTM D 2887 Distillation, | Vol %/° C. | 514/590/608/642/652 |
| IBP/30/50/90/EP | | |

The reaction conditions of the experiment conducted in Delayed Coker pilot plant according to the present invention are given in Table-4.

TABLE 4
Reaction conditions

| | Reference no. | |
|---|---|---|
| | Run No. 1 (VR | Run No. 2 (VR with |
| | without additive) | additive) |
| Additive dosing (Wt % of feed) | 0 | 1 |
| Water rate (% of total feed) | 1.2 | 1.2 |
| COT (° C.) | 495 | 495 |
| Drum bottom temperature (° C.) | 486 | 486 |
| Coke drum pressure (kg/cm²) | 1.05 | 1.05 |
| Feed rate (Kg/hr) | 8 | 8 |
| Feeding time (hr) | 12 | 12 |

The operating conditions for both the experiments were: 495° C. feed furnace outlet line temperature, 1.05 Kg/cm² coke drum pressure, 1.2 wt % steam addition to the coker feed and a feed rate maintained at about 8 kg/h. The Delayed Coking pilot plant unit was operated on 16 hr cycle time, of which 12 hrs of the cycle consisted of feeding the unit with resid feed and 4 hrs of the cycle consisted of stripping and quenching.

1 wt % (corresponding to the total feed to be processed) of the solid phase additive was fed to the coke drum before the beginning of the hydrocarbon feed flow into the coke drum. After supplying the additive to the drum, the hydrocarbon feedstock supply into the drum was started and the solid phase additive and feed were allowed to mix inside the coke drum, facilitating the cracking reaction.

The particles of additive material used had an average sphericity of 0.95 and the particle size and density was selected so as to prevent the settling of the same in the coke drum bottom. The vapors emerging from the coking drums were fed into a fractionator and recovered as liquid and gas products in product collection vessels. No coker product was recycled to the coker drum. One repeat run was conducted to confirm the yield data obtained with the use of solid phase additives.

The product yields and result obtained from the pilot plant experiments are given in Table-5.

TABLE 5
Results of Pilot plant experiment with Micron sized Additive ‘B’ (1 wt %)

| | VR | | |
|---|---|---|---|
| | without solid | VR with solid | Δ_{Change with} |
| | phase | phase | respect to base |
| | additive | additive ‘B’ | case, % |
| Coke bed height, m | 1 | 0.7 | −30% |

Yield (Basis: fresh feed)

| | | | |
|---|---|---|---|
| H₂ + C₁ + C₂ (Dry gas) | 3.47 | 5.22 | +50% |
| (wt %) | | | |
| LPG (wt %) | 3.00 | 4.25 | +41.6% |
| C₅-150 (Naphtha) | 6.09 | 8.15 | +33.8% |
| (wt %) | | | |
| 150-350 (Gas Oil) | 27.21 | 29.20 | +7.3% |
| (wt %) | | | |
| 350+ (Fuel Oil) (wt %) | 34.48 | 31.59 | −8.38% |
| Coke (wt %) | 25.74 | 21.59 | −16% |

The experimental data reported in Table-5 shows that with addition of 1 wt % of additive in the residual feed, height of coke bed in the reactor came down by 30% compared to the base case experiment with residual feedstock. This indicates that around 30% more volume of the reactor is available for feed processing, which can result in increasing the amount of feed processed in each cycle by approximately 30 volume %.

The associated benefits brought by using the additive of the present invention also includes, reduction in coke yield by 16% compared to base case. It shows that the yield of hydrocarbon product boiling above 350° C. is 8.38% lower compared to the coking process without the use of additive. The yield of hydrocarbon product boiling in the range of C₅ to 150° C. is 33% higher compared to the coking process without the use of additive. The yield of LPG and Dry gas is 41 and 47% respectively higher compared to the coking process without the use of additive. This data indicates that the solid additive added to the coking process has facilitated the cracking of heavier hydrocarbon molecules boiling above 350° C. into smaller molecules boiling in the range of C₅ to 150° C. and to gaseous hydrocarbon molecules.

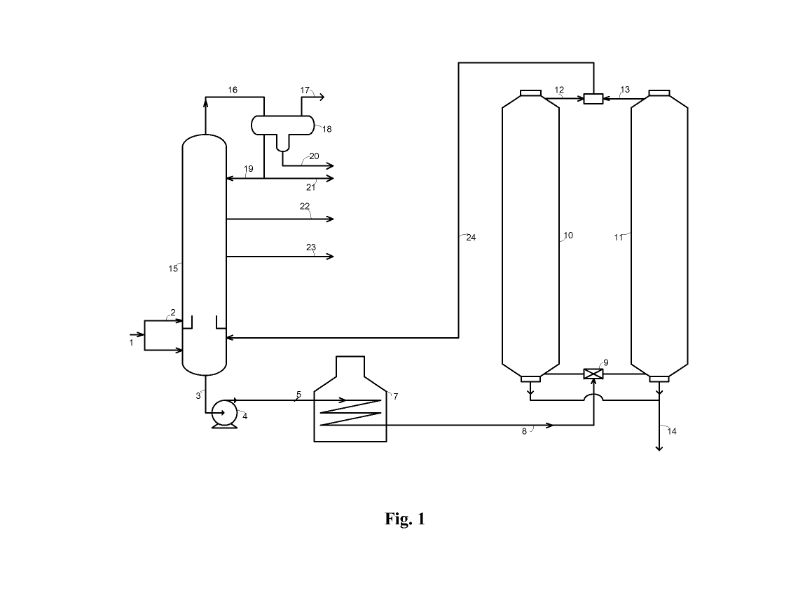

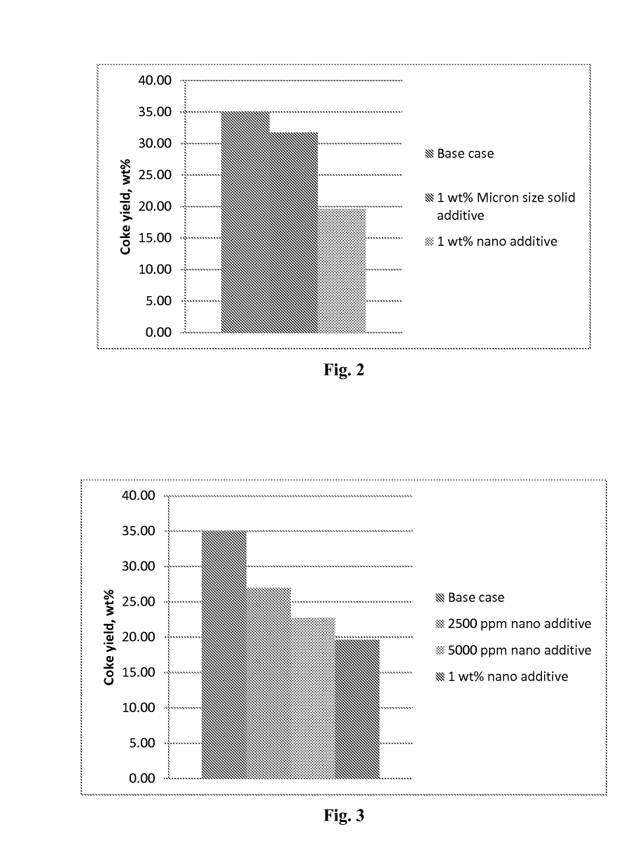

FIG. 1 illustrates a schematic representation of a conventional delayed coking process. The preheated residual hydrocarbon feedstock (1) is fed into the fractionator bottom (15), where it combines with the condensed recycle and pumped out from fractionator (3) bottom. This hydrocarbon feedstock (5) from fractionator bottom is pumped through a coker heater (7), where the desired coking temperature is achieved, causing partial vaporization and mild cracking. A vapor liquid mixture (8) exits the heater and a control valve (9) diverts it to a coking drum (10). Sufficient residence time is provided in the coking drum to allow thermal cracking till completion of coking reactions. The vapor liquid mixture is thermally cracked in the drum to produce lighter hydrocarbons (12), which vaporize and exit the coke drum. The drum vapor line temperature is the measured parameter used to represent the average drum outlet temperature. Quenching media (e.g. Gas oil or slop oil) is typically added to the vapor line (24) to quench vapors to avoid coke formation in the vapor line. When coke drum (10) is sufficiently full of coke, the coking cycle ends and the heater outlet charge is then switched from first drum (10) to a parallel coke drum (11) to initiate its coking cycle, while the filled drum (10) undergoes a series of steps like steaming, water cooling, coke cutting, vapor heating and draining, with the liquid (14) draining from the drums being fed to the blow down section. The cracked hydrocarbon vapors (24) are transferred to fractionator bottom, where they are separated and recovered. Coker heavy gas oil (HGO) (23) and Coker light gas oil (LGO) (22) are drawn off the fractionator at desired boiling temperature ranges. The fractionator overhead stream, wet gas (16) goes to separator (18), where it is separated into gaseous hydrocarbons (17), water (20) and unstabilized naphtha (21). A reflux fraction (19) is returned to the fractionator.

### Nano-Sized Additive Composition

### Example 3

Experiment was conducted in a ‘Micro coker reactor unit’ in which the hydrocarbon feedstock to be processed is loaded before the start of experiment. The reactor is heated into the desired reaction temperature using a predetermined heating rate using an electric furnace. The liquid products generated in the coking reaction are collected in the liquid collection vessel and the gaseous products are routed to vent.

Following experiments were carried out in the micro coker unit:
1. Vacuum residue feedstock
2. Vacuum residue feedstock with 1 wt % nano sized solid phase additive
3. Vacuum residue feedstock with 5000 ppm nano sized solid phase additive
4. Vacuum residue feedstock with 2500 ppm nano sized solid phase additive

Properties of feedstocks used in experiments for exemplifying the present invention are given in Table-3.

TABLE 6
Experimental conditions in Micro coker reactor

| Parameter | unit | Value |
|---|---|---|
| Reactor internal temperature (RIT) | ° C. | 486 |
| Reactor pressure | kg/cm² | 1.05 |
| Reaction time (after attaining RIT) | min | 120 |

Experiments were conducted in a ‘Micro coker reactor unit’ using the vacuum resid and nano sized solid phase Additive ‘B’ & results are provided in Table-7. Experimental conditions in Microcoker unit is as explained in the Example 1.

TABLE 7
Results of experiments carried out in Micro Coker unit using Nano-sized
Additive ‘B’

| | | Liquid | Gas | ΔCoke yield |
|---|---|---|---|---|
| | Coke, | yield, | yield, | w.r.t. Base |
| Experiment | wt % | wt % | wt % | case, % |
| VR without additive | 34.97 | 50.04 | 14.99 | 0 |
| VR + 1 wt % nano size additive | 23.12 | 35.41 | 41.47 | −33.9 |
| VR + 5000 ppm nano size | 24.47 | 42.4 | 33.1 | −30 |
| additive | | | | |
| VR + 2500 ppm nano size | 26.99 | 44.3 | 28.7 | −23 |
| additive | | | | |
| VR + 100 ppm nano size | 34.1 | 49.4 | 16.5 | −2 |
| additive | | | | |
| VR + 50 ppm nano size | 34.5 | 49.7 | 15.8 | −1 |
| additive | | | | |

The experimental data reported in Table-7 shows that coke yield reduced by 33.9% by using 1 wt % of nano additive with VR and also reflects high gas make compared to the base case indicating additive is actively participating in enhancing the cracking of heavy hydrocarbon molecules into lighter molecules.

We claim:

1. A thermal cracking additive composition for reduction of coke yield, the composition comprising:
(i) 40-85 wt % alumina,
(ii) 5-20 wt % colloidal silica having silica content ranging from 20-45 wt %, and
(iii) 0.1-13 wt % phosphate compound;
wherein said alumina comprises boehmite alumina and 2-40 wt % dispersible alumina.

2. The additive composition as claimed in claim 1, wherein the additive is micron sized with average d₅₀ particle size in the range of 5-150 microns.

3. A nano-sized thermal cracking additive composition for reduction of coke yield, the composition comprising:
(i) 40-85 wt % alumina,
(ii) 5-20 wt % colloidal silica having silica content ranging from 20-45 wt %, and
(iii) 0.1-13 wt % phosphate compound;
wherein said alumina comprises boehmite alumina and 2-40 wt % dispersible alumina of crystallite size ranging from 4.5 to 40 nano meters.

4. The nano-sized additive composition as claimed in claim 3, wherein the additive has a volume average d₅₀ diameter of 20 to 1000 nanometers.

5. The additive composition as claimed in claims 1 and 3, wherein phosphate is sourced from various phosphorous containing compounds and is selected from phosphoric acid or monobasic phosphate compounds or, dibasic phosphate compounds or, tri basic phosphate compounds or diammonium hydrogen ortho phosphate or combination thereof.

6. The additive composition as claimed in claims 1 and 3, wherein the dispersible alumina is selected from the group comprising pseudo boehmite, gamma-alumina, alpha alumina, Pural 200, Pural 400, Disperal 40 and combination thereof.

7. The additive composition as claimed in claim 6, wherein the dispersible alumina has crystallite size ranging from 4.5-40 nm.

8. A process for the preparation of additive composition as claimed in claim 1 or 3, comprising the steps of:
(a) treating boehmite alumina with demineralized water to obtain boehmite slurry;
(b) treating boehmite slurry with phosphate compound to obtain phosphate treated boehmite slurry;
(c) gelling dispersible alumina employing mineral or organic acid;
(d) adding colloidal silica to product of step (c) at pH 1 to 5;
(e) adding the phosphate treated boehmite slurry to the product of step (d);
(f) spray drying the product obtained in step (e);
(g) calcining the spray dried particles of step (f) to obtain the additive composition.

9. The process as claimed in claim 8, wherein the mineral or organic acid is selected from nitric acid, formic acid, and acetic acid.

10. The process as claimed in claim 8, further comprising the step of milling the calcined additive composition to obtain nano-sized additive composition.

11. A process for reducing coke yield in Delayed Coking process comprising the steps of:
(a) contacting a feedstock with the additive as claimed in claim 1 or 3 in a coke drum; and
(b) separating the cracked product to obtain different fractions.

12. The process as claimed in claim 11, wherein the contacting of feedstock with the additive is carried out by:
(a) feeding a predetermined quantity of the additive to the coke drum before feeding the hydrocarbon feedstock into the coke drum;
(b) mixing the additive at a predetermined flow rate into the hydrocarbon feedstock before entering the feed heater furnace, in the transfer line;
(c) injecting the solid phase additive into the coke drum during the feeding of hydrocarbon into the drum, through injection nozzle(s) located at suitable part of the drum, preferably at the top section; or
(d) a combination of any of (a), (b) and (c).

13. The process as claimed in claim 11 wherein step (a) of the process is performed at a temperature range of 450-600° C.

14. The process as claimed in claim 11, wherein step (a) of the process is performed at a pressure range of 0.5-5 kg/cm².

15. The process as claimed in claim 11, wherein when micron-sized additive is used, the concentration of the additive is in the range of 0.01-5 wt % and when nano-sized additive is used, the concentration of additive is in the range of 50 ppm to 40,000 ppm.

16. The process as claimed in claim 11, wherein when the additive is micron sized, said additive is used in solid form or in a dispersion form.

17. The process as claimed in claim 11, wherein when the additive is nano-sized, the additive is used in dispersion form.

18. The process as claimed in claim 16 or 17, wherein the additive in dispersion form is used in combination with a liquid dispersion medium selected from the group consisting of feedstock, gas oil, lighter hydrocarbons, residue, solvents, water or mixtures thereof.

19. The process as claimed in claim 11, wherein the bottom product (boiling above 350° C.+) yield is reduced by 1-3 wt %.

20. The process as claimed in claim 11, wherein the LPG yield is increased by 1-2 wt %.

21. The process as claimed in claim 11, wherein the naphtha (C5-150° C.) yield is increased by 1-2 wt %.

22. Use of the additive composition as claimed in claim 1 or 3 for reducing coke yield in Delayed coking process, wherein the reduction in coke yield is 1 wt % to 5 wt % with respect to base case.
